(19) United States
(12) Patent Application Publication
(10) Pub. No.: US 2003/0182564 A1
(43) Pub. Date: Sep. 25, 2003

(54) Data protection system with address re-mapping mechanism for the protected zone of storage devices or media

(76) Inventors: Jing-Shiun Lai, Tai-Chung City (TW); Ling-Ying Nain, Tai-Chung City (TW); Po-Hsu Lin, Tai-Chung Hsien (TW); Sheng-Kai Lin, Tai-Chung Hsien (TW)

Correspondence Address: CHARLES E. BAXLEY ESQUIRE, Hart, Baxley, Daniels & Holton, 59 John St. 5 Fl., New York, NY, 10038, US

(21) Appl. No.: 10/103,254

(22) Filed: Mar. 19, 2002

(51) Int. Cl. H04L 9/32

(52) U.S. Cl. 713/193

(57) ABSTRACT

A data protection system is constructed to protect data stored on storage devices or media by changing the mapping between the physical position and the operating system acknowledged position of storage cells.

It includes a storage space address conversion module which converts the default space address sequence of the protected zone of storage devices or media designated by the system to the re-mapped space address sequence, and a data encryption/decryption module which encrypts plaintext into ciphertext using an encryption algorithm with an encryption key before saving the data and decrypts ciphertext back to plaintext using a decryption algorithm with a decryption key after reading of data.

Therefore those computers without the data protection system and those computers with different re-mapping mechanism cannot read the correct data out of the protected zone of the storage devices or media.

### BACKGROUND OF THE INVENTION

1. Field of the Invention

This invention relates to a data protection system that protects the data stored on computer peripheral storage devices or media, more particularly to a data protection system which protects the data stored on the protected zone of storage devices or media by re-mapping the address of the protected zone of the storage devices or media, encrypting the data to be stored before writing it to the storage devices or media, and decrypting the data right after it is read out of the storage devices or media.

2. Description of the Related Art

Along with fast improvement of computer technology, almost all government organizations, research centers, academic institutes, and companies use computers for documents writing. A variety of computer peripheral storage devices or media have been developed for digital data storage, including documents, technical data, confidential data, . . . etc. People are used to store data, prepare copies of data for backup or carrying them from place to place with peripheral data storage devices or media because of ease to carry, space saving and long life-time usage. Although data storage devices or media provide efficient way of storing data, they also become the target of computer criminals. Computer criminals may steal confidential data via the Internet. Various data protection methods have been developed to protect data by encrypting plaintext into ciphertext. However, conventional data protection methods can be easily broken by using more computers.

### SUMMARY OF THE INVENTION

The invention provides a data protection system for the protected zone of storage devices or media, which protect data stored on the storage devices or media from unauthorized access by configuring an address re-mapping mechanism according to an address conversion key and the protected zone default address sequence to convert protected zone default address sequence to protected zone re-mapped address sequence. Therefore those computers without the data protection system and those computers with the data protection system but different re-mapping mechanism cannot read the correct data out of the protected zone of the storage devices or media.

The protection is achieved by storing data to and reading data from the storage cells corresponding to re-mapped addresses instead of system-designated addresses. And the data is encrypted before being stored and decrypted after being read out. The embodiment includes initially generating an address re-mapping rule according to an address conversion key CNVkey and the protected zone default address sequence [Pi, i=0, 1, . . . , n], and then using the address re-mapping rule to setup a protected zone address re-mapping table which can be used for look-up to convert the protected zone default address sequence [Pi, i=0, 1, . . . , n] into the protected zone re-mapped address sequence [Si, i=0, 1, . . . , n] afterwards. When storing data, the plaintext [Di, i=0, 1, . . . , m] is encoded into the ciphertext [Ri, i=0, 1, . . . , k] using an encryption algorithm with an encryption key, and then the access domain default address sequence [Ui, i=0, 1, . . . , x] is converted into the access domain re-mapped address sequence [Vi, i=0, 1, . . . , x] using the address re-mapping rule or the address re-mapping table. Finally, the ciphertext is stored to the storage device according to the access domain re-mapped address sequence. When reading data, the system designated access domain default address sequence [Ui, i=0, 1, . . . , x] is converted into the access domain re-mapped address sequence [Vi, i=0, 1, . . . , x] using the address re-mapping rule or the protected zone address re-mapping table, and then the ciphertext [Ri, i=0, 1, . . . , k] is read out and decrypted into the plaintext [Di, i=0, 1, . . . , m] using the decryption algorithm with the decryption key. The aforesaid protected zone default address sequence means an ordered sequence of numbers representing the addresses designated by the base computer system for the protected zone of storage devices or media while sequentially access the storage cells within the protected zone. The aforesaid access domain default address sequence means a sequence of addresses originally designated by the base computer system while accessing data within the access domain.

### BRIEF DESCRIPTION OF THE DRAWINGS

FIG. 1 is a block diagram of a preferred embodiment of the present invention.

FIG. 2 is a block diagram of another preferred embodiment of the present invention.

FIG. 3 is a block diagram of another preferred embodiment of the present invention.

FIG. 4 is a protected zone address re-mapping table setup using a sample address re-mapping rule.

FIG. 5 is another protected zone address re-mapping table setup using another sample address re-mapping rule.

FIG. 6 is a table showing an example of the conversion of plaintext into ciphertext and the conversion of ciphertext to plaintext.

FIG. 7 is a graph illustrating conversion between the access domain default address sequence and the access domain re-mapped address sequence using a sample of the protected zone address re-mapping table.

### DETAILED DESCRIPTION OF THE PREFERRED EMBODIMENT

Before the present invention is described in greater details, it should be noted that same reference numerals have been used to denote like elements throughout the disclosure.

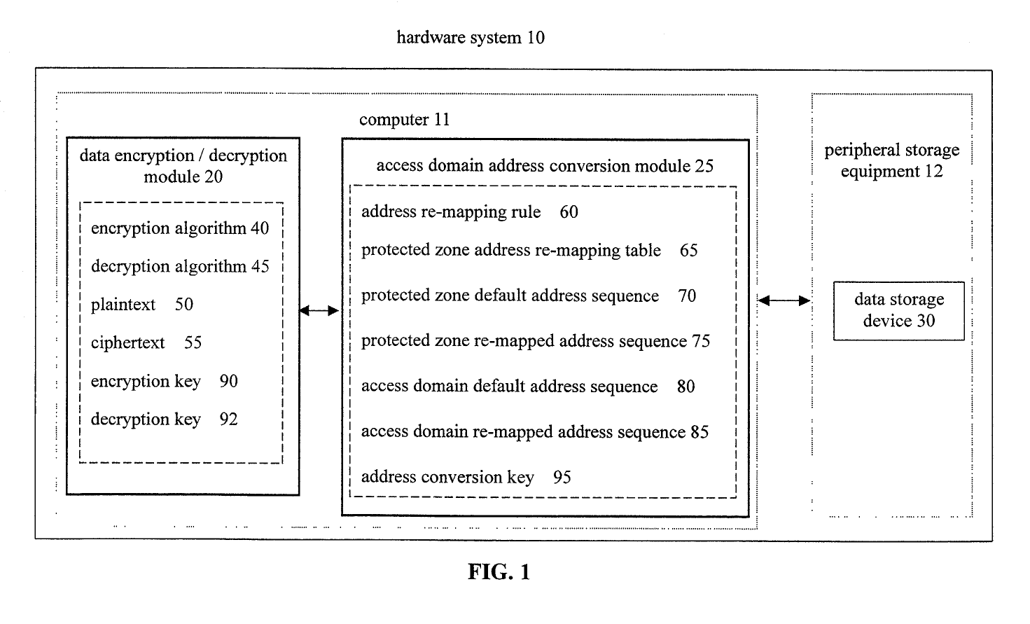

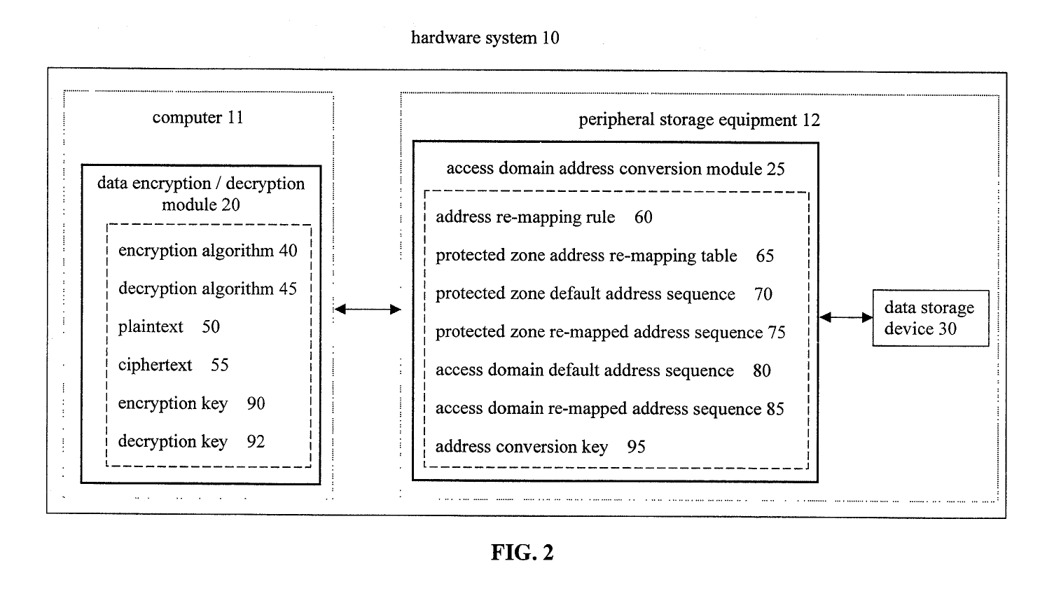

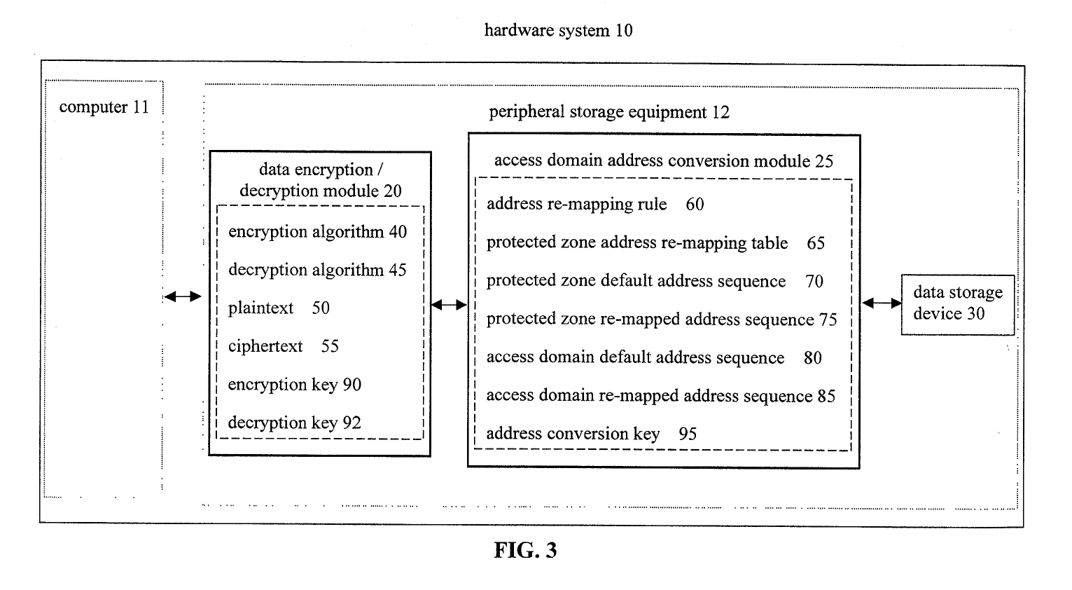

FIG. 1 is a block diagram of a preferred embodiment of the present invention. As illustrated in FIG. 1, the hardware system 10 of this configuration comprises a computer 11 providing a data encryption/decryption module 20 and an access domain address conversion module 25, and a peripheral storage equipment 12 having a data storage device 30. FIG. 2 is a block diagram of another preferred embodiment of the present invention. As illustrated in FIG. 2, the hardware system 10 of this configuration comprises a computer 11 providing a data encryption/decryption module 20, and a peripheral storage equipment 12, which contains an access domain address conversion module 25 and a data storage device 30. FIG. 3 is a block diagram of another preferred embodiment of the present invention. As illustrated in FIG. 3, the hardware system 10 of this configuration comprises a computer 11, and a peripheral storage equipment 12 which contains a data encryption/decryption module 20, an access domain address conversion module 25, and a data storage device 30.

The access domain address conversion module 25 provides the functions of:

(A) setting up an address re-mapping rule 60 according to an address conversion key 95 and a protected zone default address sequence 70, and using the address re-mapping rule 60 to set up a protected zone address re-mapping table 65, which can be used for look-up to convert the protected zone default address sequence 70 to the protected zone re-mapped address sequence 75; and

(B) using the protected zone address re-mapping rule 60 or the address re-mapping table 65 to convert the system designated access domain default address sequence 80 to the access domain re-mapped address sequence 85.

The data encryption/decryption module 20 provides the functions of:

(A) encrypting plaintext 50 into ciphertext 55 using an encryption algorithm 40 with an encryption key 90; and

(B) decrypting ciphertext 55 into plaintext 50 using a decryption algorithm 45 with a decryption key 92.

According to the preferred embodiments, when storing data to the protected zone of the storage device or media, the data encryption/decryption module 20 encrypt plaintext 50 into ciphertext 55, then the access domain address conversion module 25 calculate the access domain re-mapped address sequence 85 corresponding to the system designated access domain default address sequence 80, and then save ciphertext 55 to the storage cells corresponding to the access domain re-mapped address sequence 85. On the contrary, when reading data, the access domain address conversion module 25 calculate the access domain re-mapped address sequence 85 corresponding to the system designated access domain default address sequence 80, then read ciphertext 55 from the storage cells corresponding to the access domain re-mapped address sequence 85, and then the data encryption/decryption module 20 decrypt ciphertext 55 into plaintext 50.

For the preferred embodiments illustrated in FIG. 1, 2, and 3, the operations performed are outlined hereinafter:

The access domain address conversion module 25 sets up an address re-mapping rule 60 with an address conversion key 95 and a protected zone default address sequence 70 [Pi, i=0, 1, . . . , n], and then the address re-mapping rule 60 is used to set up a protected zone address re-mapping table 65, which converts protected zone default address sequence 70 [Pi, i=0, 1, . . . , n] into protected zone re-mapped address sequence 75 [Si, i=0, 1, . . . , n]. The address re-mapping rule 60 is a defined one-to-one and onto function mapping from domain [Pi, i=0, 1, . . . , n] to range [Si, i=0, 1, . . . , n] with the address conversion key 95 and the protected zone default address serial 70 [Pi, i=0, 1, . . . , n] as parameters. Next, we use some examples to illustrate it:

(A) Define the address re-mapping rule 60 as a function of the range of the protected zone address:

For the example shown in FIG. 4, the protected zone default address sequence 70 is [0, 1, . . . , 1000], that is, the addresses of storage cells in the protected zone are in the range of 0 and 1000, then define the address re-mapping rule 60 as:

f(x)=1000−x

therefore the address re-mapping rule 60 converts the protected zone default address sequence 70 [0, 1, . . . , 1000] into protected zone re-mapped address sequence 75 [1000, 999, . . . , 0].

(B) Define the address re-mapping rule 60 as a function of the address conversion key and the range of the protected zone address:

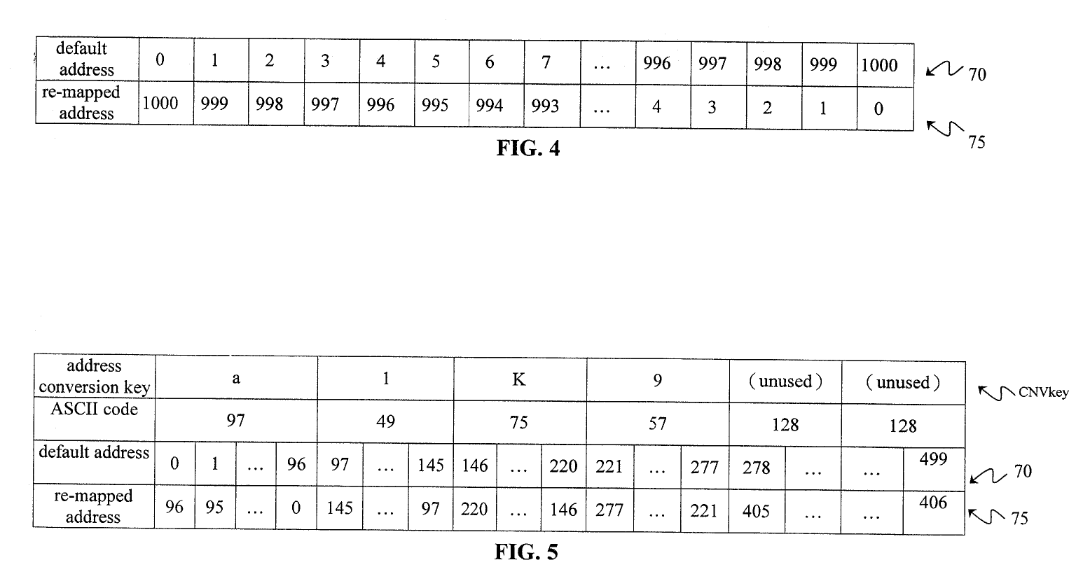

For the example shown in FIG. 5, suppose that the protected zone default address sequence 70 is [0, 1, . . . , 499] and the address conversion key 95 is “a1K9”, which corresponds to ASCII code 97-49-75-57. First, use code 128 to pad the code sequence, forming a new character code sequence 97-49-75-57-128-128-128-128 . . . , then define the address conversion rule 60 as:

$$f ( x ) = \begin{matrix}96 - x & if & 0 ≦ x < 97 \\ 145 - x + 97 & if & 97 ≦ x < 146 \\ 220 - x + 146 & if & 146 ≦ x < 221 \\ 277 - x + 221 & if & 221 ≦ x < 278 \\ 405 - x + 278 & if & 278 ≦ x < 406 \\ 499 - x + 406 & if & 406 ≦ x < 500\end{matrix}$$

therefore, the address re-mapping rule 60 converts the protected zone default address sequence 70 [0, 1, . . . , 96, 145, . . . , 220, . . . , 227, . . . , 499] into the protected zone re-mapped address sequence 75 [96, 95, . . . , 0, . . . , 97, 146, . . . , 221, . . . , 406].

The procedure of storing data to the protected zone of the storage device or media is described as follows:

(A) The encryption/decryption module 20 use an encryption algorithm 40 to encrypt plaintext 50 [Di, i=0, 1, . . . , m] into ciphertext 55 [Ri, i=0, 1, . . . , k] with the encryption key 90, where the total length of plaintext 50 is greater than or equal to that of ciphertext 55. This is to encode data to be saved into random gibberish to prevent others from reading out the data correctly by analyzing the data context. The following example is used to illustrate this operation:

Assume the encryption key 90 is “SSun”, which corresponds to ASCII code 0x53-0x53-0x75-0x6E. Define the symmetrical encryption/decryption algorithm 40 as:

| | | |
|---|---|---|
| Xi = | Xi \hat{ } Xi − 1 | if i ≠ 0 |
| | Xi \hat{ } 0×5353756E | if i = 0 |

where i=8, 7, 6, . . . , 0, Xi is a DWORD, and “\hat{ }” means “Exclusive Or” operation.

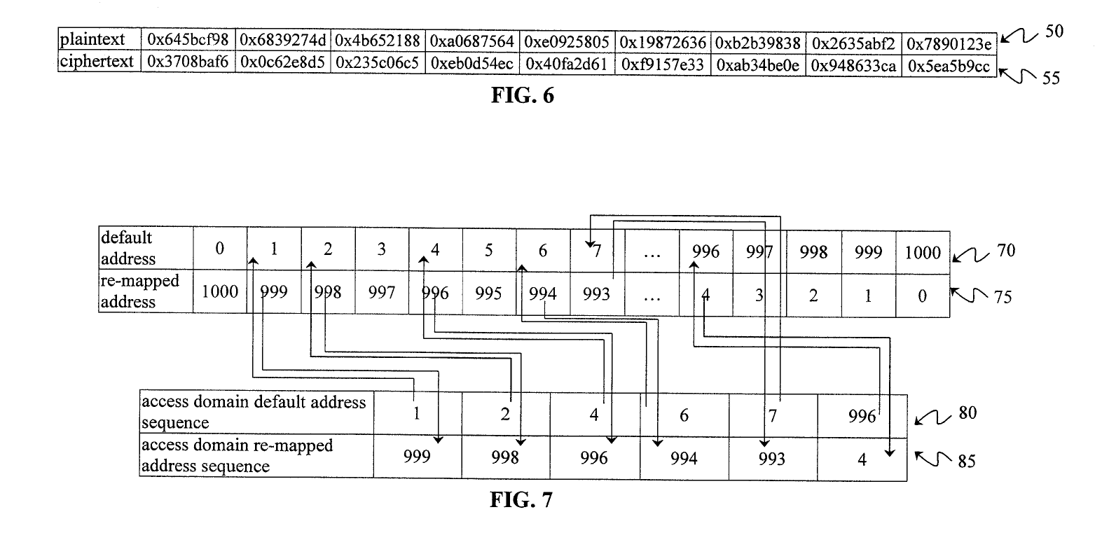

As shown in FIG. 6, using this algorithm with the encryption key 90 “SSun”, plaintext 50 [0x645BCF98, 0x6839274D, 0x4B652188, 0x7890123E] is encrypted into ciphertext 55 [0x3708BAF6, 0x0C62E8D5, 0x235C06C5, 0x5EA5B9CC].

(B) The access domain address conversion module 25 use the protected zone address re-mapping table 65 or the address conversion rule 60 to convert the access domain default address sequence 80 [Ui, i=0, 1, . . . , x] designated by the base computer system to the access domain re-mapped address sequence 85 [Vi, i=0, 1, . . . , x].

As illustrated in FIG. 7, the address re-mapping rule 60 and the protected zone address re-mapping table 65 are the same as that shown in FIG. 4, thus the access domain default address sequence 80 [1, 2, 4, 6, 7, 996] is converted to the access domain re-mapped address sequence 85 [999, 998, 996, 994, 993, 4].

Store the ciphertext 55 [Ri, I=0, 1, . . . , k] to the storage device or media according to the access domain re-mapped address sequence 85 [Vi, i=0, 1, . . . , x]. For the example shown in FIG. 7, ciphertext 55 [Ri, i=0, 1, 2, . . . , k] is stored to the storage cells corresponding to the access domain re-mapped address sequence 85 [999, 998, 996, 994, 993, 4].

The procedure of reading data from the protected zone of the storage device or media is described as follows:

(A) The access domain address conversion module 25 use the protected zone address re-mapping table 65 or the address conversion rule 60 to convert the access domain default address sequence 80 [Ui, i=0, 1, . . . , x] designated by the base computer system to the access domain re-mapped address sequence 85 [Vi, i=0, 1, . . . , x].

As illustrated in FIG. 7, the address re-mapping rule 60 and the protected zone address re-mapping table 65 are the same as that shown in FIG. 4, thus the access domain default address sequence 80 [1, 2, 4, 6, 7, 996] is converted into the access domain re-mapped address sequence 85 [999, 998, 996, 994, 993, 4].

Read ciphertext 55 [Ri, i=0, 1, 2, . . . , k] from the storage device or media according to the access domain re-mapped address sequence 85 [Vi, i=0, 1, . . . , x]. For the example shown in FIG. 7, ciphertext 55 [Ri, i=0, 1, 2, . . . , k] is read from the storage cells corresponding to the access domain re-mapped address sequence 85 [999, 998, 996, 994, 993, 4].

The data encryption/decryption module 20 use the decryption algorithm 45 to decrypt ciphertext 55 [Ri, i=0, 1, 2, . . . , k] into plaintext 50 [Di, i=0, 1, 2, . . . , m] with the decryption key 92. The following example is used to illustrate this operation:

Assume the decryption key 92 is “SSun”, which corresponds to ASCII code 0x53-0x53-0x75-0x6E. Define the symmetrical decryption algorithm 45 as:

| | | |
|---|---|---|
| Xi = | Xi \hat{ }0×5353756E | if i = 0 |
| | Xi \hat{ }Xi − 1 | if ≠ 0 |

where i=0, 1, 2, . . . , 8, Xi is a DWORD, and “\hat{ }” means “Exclusive Or” operation.

As shown in FIG. 6, using this decryption algorithm and the decryption key 92 “SSun”, ciphertext 55 [0x3708baf6, 0x0c62e8d5, 0x235c06c5, . . . , 0x5ea5b9 cc] is decrypted into plaintext 50 [0x645bcf98, 0x6839274d, 0x4b652188, 0x7890123e].

It will therefore be seen that the foregoing represents a highly extensible and advantageous approach to the protection of data on storage devices or media. The terms and expressions employed herein are used as terms of description and not of limitation, and there is no intension, in the use of such terms and expressions, of excluding any equivalents of the features shown and described or portions thereof, but it is recognized that various modifications are possible within the scope of the invention claimed.

What is claimed is:

1. A data protection system used to protect the data stored on the storage device or media, which consists of countable storage cells of which cell size can be changed as requested. And there exists an ordered sequence of numbers representing the addresses of the storage cells, which are used by the computer system for accessing the data in the corresponding storage cells. The data protection system comprises an access domain address conversion module and a data encryption/decryption module, wherein:
said access domain address conversion module converts the access domain default address sequence designated by the system to the access domain re-mapped address sequence and then accesses data from the storage cells corresponding to the re-mapped addresses.
said data encryption/decryption module encrypts plaintext into ciphertext using an encryption algorithm with an encryption key before the data is stored, and decrypts ciphertext back to plaintext using a decryption algorithm with a decryption key after the data is read.

2. The data protection system as claimed in claim 1, wherein said access domain address conversion module comprises an address re-mapping rule and an address conversion key, said address re-mapping rule defining a one-to-one and onto function with said address conversion key, whose domain and range are the protected zone default address sequence. Defined function may be a polynomial function, a triangle function, a dynamic function, a logarithm function, an exponential function, . . . etc. Defined function may be either reproducible or irreproducible, i.e. the defined functions may not be the same even with the same address conversion key and the same protected zone of storage device or media.

3. The data protection system as claimed in claim 2, wherein said access domain address conversion module further comprises a protected zone address re-mapping table, which is created with the result of the conversion of the protected zone default address sequence to the protected zone re-mapped address sequence using said address re-mapping rule.

4. The data protection system as claimed in claim 3, wherein the address conversion is achieved by using a mixture of said address re-mapping rule and said protected zone address re-mapping table, so that the calculation is simpler than that of using said re-mapping rule only and the memory space required is less than that of using said protected zone re-mapping table only.

5. The data protection system as claimed in claim 3, wherein said address re-mapping rule is a function of random number, that is, said address conversion table is created with a set of irreproducible random numbers. Hereafter, the address conversion can only be accomplished using said address re-mapping table.

6. The data protection system as claimed in claim 1, wherein the unit size of the storage cells is different from the default size, i.e. the address for the storage device or media with the specified unit size can be calculated from the address for the storage device or media with the default unit size using the relationship between the specified unit size and the default unit size.

7. The data protection system as claimed in claim 1, wherein the protected zone of storage devices or media can be the whole region or parts of the region of the storage device or media. If being parts of the region, that space can be contiguous or not.

8. The data protection system as claimed in claim 1, wherein said data encryption/decryption module and said access domain address conversion module are provided in the computer.

9. The data protection system as claimed in claim 1, wherein said data encryption/decryption module is provided in the computer, and said access domain address conversion module is provided in the peripheral storage equipment connected to the computer.

10. The data protection system as claimed in claim 1, wherein said data encryption/decryption module and said access domain address conversion module are provided in the peripheral storage equipment connected to the computer.

11. The data protection system as claimed in claim 1, wherein the total length of said ciphertext is larger than that of said plaintext, and parts of said ciphertext is stored on the storage space outside the protected zone of the storage device or media.

12. The data protection system as claimed in claim 1, wherein the encryption/decryption algorithm is symmetrical. It can be Position-Value Exchange algorithm, Substitution algorithm, DES algorithm, Feal algorithm, IDEA algorithm, SkipJack algorithm, Stream Ciphering algorithm, Lucifer algorithm, RC5 algorithm, Blowfish algorithm, GOST algorithm, New DES algorithm, Loki algorithm, . . . etc.

13. The data protection system as claimed in claim 1, wherein the encryption/decryption algorithm is asymmetrical. It can be RSA algorithm, Rabin algorithm, McEliece algorithm, KnapSack algorithm, Probabilitistic encryption algorithm, Elliptic Curve algorithm, LUC algorithm, Chaotic algorithm, . . . etc.

14. The data protection system as claimed in claim 1, wherein said address conversion key CNVkey and said encryption/decryption key can be obtained from user input, storage devices or media, computer devices, or computer network.

15. The data protection system as claimed in claim 1, wherein said encryption/decryption algorithm is an Identity function, thus said data encryption/decryption module can be omitted since the ciphertext and the plaintext are the same.
